(19) United States
(12) Patent Application Publication
(10) Pub. No.: US 2002/0036402 A1
(43) Pub. Date: Mar. 28, 2002

(54) Gas bag

(75) Inventors: Jurgen Heigl, Bobingen (DE); Claus Kongeter, Reichenbach (DE)

Correspondence Address: Tarolli, Sundheim, Covell,, Tummino & Szabo L.L.P., 1111 Leader Building, 526 Superior Avenue, Cleveland, OH, 44114-1400, US

(73) Assignee: TRW Occupant Restraint Systems GmbH & Co. KG

(21) Appl. No.: 09/999,500

(22) Filed: Oct. 19, 2001

Related U.S. Application Data
(62) Division of application No. 09/665,469, filed on Sep. 20, 2000.

(30) Foreign Application Priority Data
Sep. 23, 1999 (DE) 299 16 823.9
Nov. 8, 1999 (DE) 299 19 574.0

(51) Int. Cl. B60R 21/16

(52) U.S. Cl. 280/743.2; 280/728.1

(57) ABSTRACT

A gas bag for a vehicle occupant restraint system comprises two superimposed plies of fabric and a tether means attached to the plies of fabric. The tether means is formed by a seam realized with a thread slack and interconnecting the plies of fabric.

This invention relates to a gas bag for a vehicle occupant restraint system, comprising two superimposed plies of fabric and a tether means which, when the gas bag is inflated, delimits the distance between the plies of fabric and is attached to the same.

In particular in the case of a side gas bag it is important that in the entire restraint area, i.e. in that area in which an impact of a vehicle occupant is likely to occur, a sufficient, rather constant gas bag thickness is available. The expansion of a gas bag can be influenced and controlled by internally disposed tethers. These tethers are each disposed between two superimposed plies of fabric and sewn to the same or interwoven with the same by a special weaving technique. There are not very much possibilities for fashioning the gas bag with only one tether, as with only two points of attachment action across an area, such as an anchoring, can hardly be achieved. Therefore, a plurality of tethers must be used. This involves a high manufacturing effort. If the attachment of the tethers to the plies of fabric is effected by means of seams, these seams must be applied through the inflation opening of the gas bag. In addition, the attachment of both ends of the tethers to individual points has a negative influence on a constant thickness of the restraint area, and on the other hand high forces act on the gas bag fabric at the points of attachment, which forces can lead to a damage of the gas bag in the case of restraint.

The invention provides a gas bag for a vehicle occupant restraint system, in which with only one tether means a substantially constant gas bag thickness is achieved over a large area of the gas bag with little manufacturing effort, and in which the forces occurring in the case of restraint are distributed over a larger surface of the gas bag than in a conventional gas bag with only one tether.

In accordance with the invention, the tether means disposed on the inside are formed by at least one seam realized with a thread slack. Such seam with a thread slack can be incorporated from the outside in the superimposed plies of fabric. When applying the seam, the plies of fabric can thus lie flat one above the other, and a conventional sewing technique can be employed.

In the folded condition of the gas bag, the thread slack of the seam forms loops which are disposed between the plies of fabric or on the outside of one of the plies of fabric. When the gas bag expands, the thread slack is pulled out until the loops are eliminated. The multitude of tensioned threads in the interior of the gas bag acts like a tether which delimits the expansion of the gas bag in the direction of extension of the threads. Since the application of a seam with a thread slack can be effected with little effort in terms of manufacturing technology, it can on the one hand be formed in a length which can be much larger than the width of a conventional tether, so that forces occurring in the case of restraint can be distributed over the surface of the gas bag in a better way. On the other hand, novel designs of the gas bag can be taken into account, which would be too expensive when using conventional tethers. It is thus possible without any major effort to provide the gas bag with a number of seams with a thread slack, which seams act as tether means and control the shape of the gas bag up into the edge portions thereof when the same is deployed and expands.

Particularly suitable types of seams are the double saddle stitch seam and the double chain stitch seam. In both cases, the thread slack is preferably formed in the underthread.

In accordance with the invention, there is provided a device for forming a seam with a thread slack, in which during sewing a spacer is disposed between the two plies of fabric of the gas bag, so as to obtain a seam which is realized with an extremely large slack. This spacer approximately has the desired thickness of the inflated gas bag and is removed after the sewing operation. The thread slack can thus be achieved without complex sewing techniques. When the gas bag is folded, the slack thread of the seam thus lies inside the gas bag and is only tensioned when the gas bag is deployed. In this way, a large-surface tether function can be realized. The seam can also perform the function of the formation of chambers.

In accordance with the invention there is furthermore provided a gas bag with a tether means attached to the plies of fabric, the tether means constituting an X-shaped tether structure and being attached to each ply of fabric via two points of attachment each. On the one hand, the four points of attachment reduce the load exerted by the X-shaped tether means on the gas bag fabric in the case of restraint, as compared to a conventional tether with one point of attachment each at the plies of fabric, and on the other hand the choice of the formation of the tether structure and the arrangement of the points of attachment provides various possibilities for fashioning the gas bag. The tether means itself can be prefabricated outside the gas bag, in order to reduce the manufacturing effort.

In accordance with the invention, the tether means may also be formed of a circular piece of material, which at its periphery is connected across an area with the one ply of fabric and in a middle portion thereof is connected across an area with the other ply of fabric. A piece of material can be attached to a larger surface than a conventional tether, in order to reduce loads acting on the gas bag fabric. This embodiment also offers a wide variety of possibilities for fashioning the gas bag.

In a further advantageous embodiment the tether means is made of a portion in which folds of the fabric parts of the gas bag have been sewn to each other. This embodiment does not require any additional components, and there is a wide variety of possibilities for fashioning the gas bag. A division of the gas bag into chambers can also be achieved.

In accordance with the invention, the tether means may also be formed of a catch thread which with a thread slack lies between the two plies of fabric and is alternately attached to the two plies of fabric. Here as well, the forces acting on the gas bag fabric in the case of restraint are distributed over a surface area of the fabric by means of the numerous points of attachment. For providing such a catch thread attached with a thread slack, a method is provided in which the superimposed plies of fabric are partly unfolded towards one end. Then, the catch thread is arranged on the two unfolded plies of fabric in the shape of a loop and alternately sewn punctually to one ply of fabric each. Subsequently, the gas bag can be folded and be sealed gastight at its border for instance by means of a seam.

All embodiments have in common that with only one tether means the gas bag thickness can be kept constant over a larger area of the gas bag. On the one hand, the forces occurring in the case of restraint are thereby distributed over the gas bag fabric. On the other hand, incorporating only one tether means involves less manufacturing effort than would be the case with a conventional gas bag with a plurality of tethers.

Further advantages and features of the invention can be taken from the following description of several embodiments of the invention with reference to the enclosed drawings, in which:

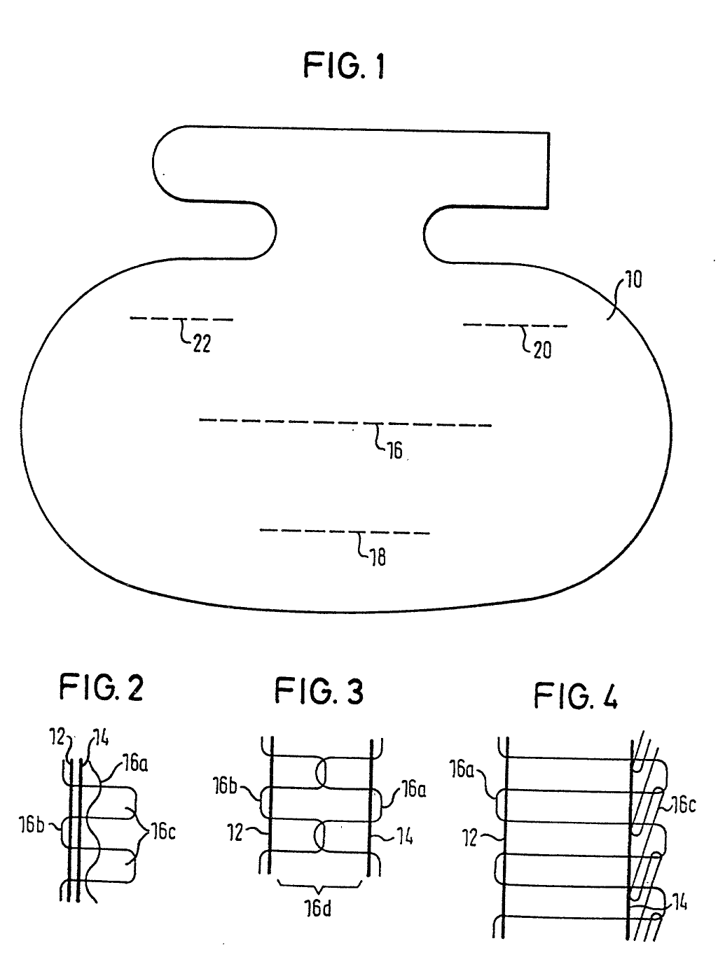

FIG. 1 schematically shows a gas bag according to the invention in the expanded state;

FIG. 2 schematically shows a sectional view of two superimposed plies of fabric which are connected by a seam with a thread slack, the thread slack in the form of individual loops being disposed on the outside of one of the plies of fabric;

FIG. 3 shows a sectional view of two plies of fabric connected by a seam with a thread slack, the thread slack being formed by thread loops lying between the plies of fabric;

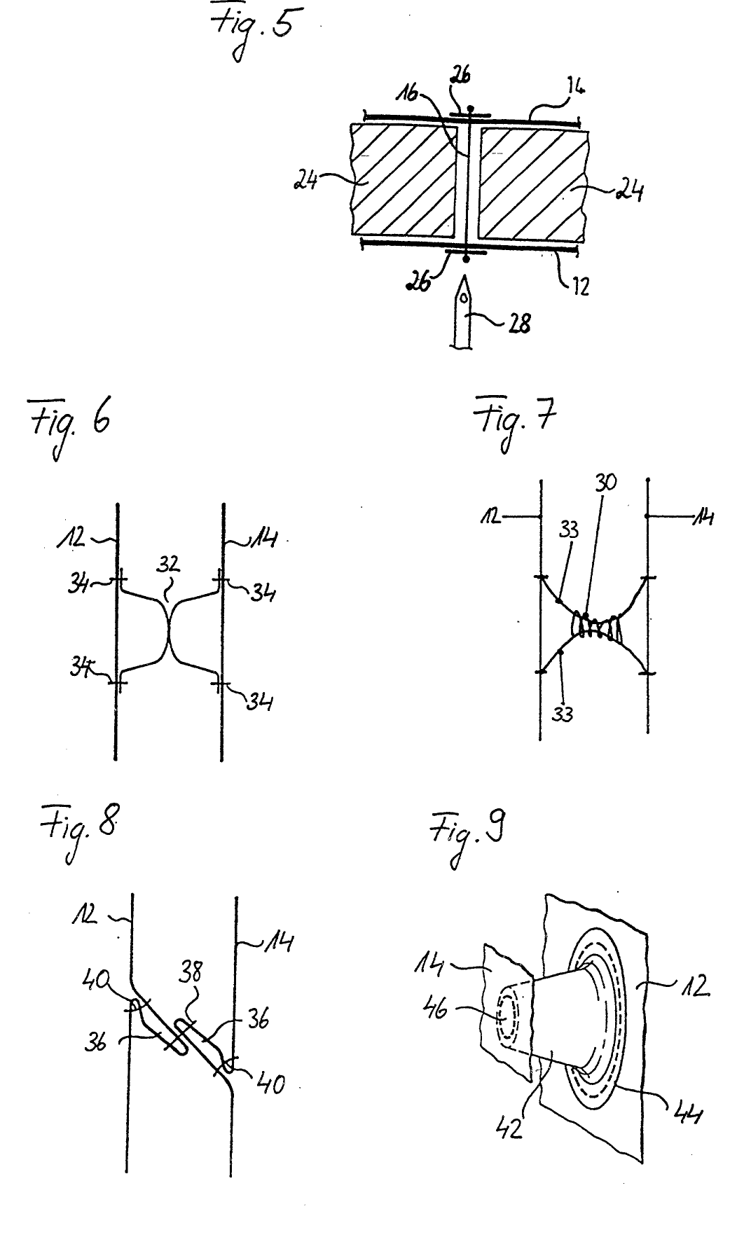

FIG. 4 shows a sectional view of two plies of fabric connected by a seam with a thread slack, the thread slack being formed in part between the plies of fabric and in part on the outside of one of the plies of fabric;

FIG. 5 schematically shows an arrangement for making a seam with a large thread slack;

FIG. 6 shows a sectional view of two plies of fabric which are connected with each other by an X-shaped tether means;

FIG. 7 shows a sectional view of an X-shaped tether means which is formed by two tethers connected with each other by a tear seam;

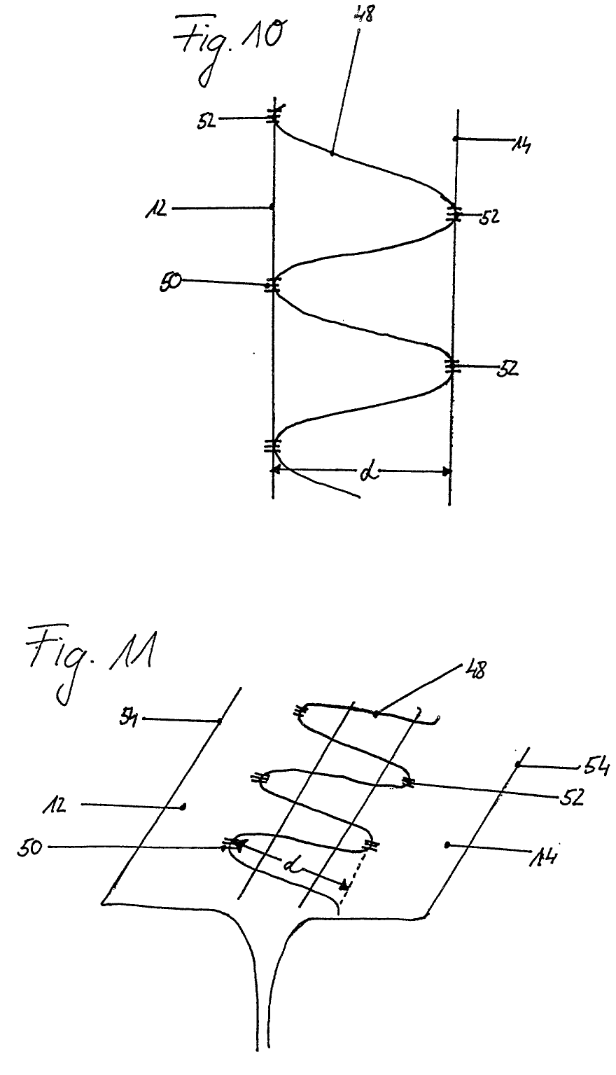

FIG. 8 shows a sectional view of two plies of fabric, the tether means being formed of sewn folds of the fabric parts;

FIG. 9 shows a sectional view of two plies of fabric, the tether means being formed of an additional fabric part;

FIG. 10 shows a sectional view of two plies of fabric, the tether means being formed by a catch thread;

FIG. 11 schematically shows a method of producing the tether means illustrated in FIG. 10.

The gas bag 10 shown in FIG. 1 in the expanded state has two superimposed plies of fabric 12, 14 which may be formed in one piece or be sewn to each other at their edges. Approximately in the middle of the gas bag 10 a seam 16 made with a thread slack is disposed, which seam linearly extends across the middle main area of the shell surface area of the gas bag. This seam 16 replaces an internally disposed tether of usual gas bag designs. Expedient embodiments of the seam 16 are shown in FIGS. 2, 3 and 4.

In the embodiment shown in FIG. 2, the seam 16 consisting of upper thread 16a and underthread 16b is made with a thread slack, which slack is formed by thread loops 16c unilaterally disposed on the outside of the ply of fabric 14.

In the embodiment shown in FIG. 3, the seam 16 consists of upper thread 16a and underthread 16b with knotted thread overhangs 16d lying between the plies of fabric 12, 14. In the embodiment shown in FIG. 4, the seam 16 consists of upper thread 16a and underthread 16b, the thread slack being formed in part between the plies of fabric 12, 14 and in part externally on the side of the ply of fabric 14 in the form of thread loops 16c.

In the preferred embodiments, the seam 16 is realized as double lock stitch seam or as double chain stitch seam.

FIG. 5 illustrates a device for making a seam with a large thread slack between the two plies of fabric, as it is for instance present in the embodiment shown in FIG. 3. Between the two plies of fabric 12, 14 two spacers 24 are incorporated, whose thickness substantially corresponds to the thickness of the gas bag. The spacers 24 spare the point where the seam is going to be made. Reinforcement layers 26 may be provided at the respective outer surfaces of the plies of fabric 12, 14. The seam 16 is made with a sewing needle 28 with a stroke that corresponds to the thickness of the spacers 24. In this way, the entire thread slack can be arranged between the plies of fabric 12, 14.

The seam 16 acts as tether means for delimiting the expansion of the gas bag 10 between its plies of fabric 12, 14. Since the seam 16 is applied from the outside at the superimposed plies of fabric 12, 14, it does not mean an increased manufacturing effort to make the seam with a length that can be much larger than the width of a conventional tether. Therefore, the dynamic loads occurring during the delimiting function are distributed over the surface of the gas bag in a better way. Furthermore, additional catch seams may be provided at the gas bag without any major manufacturing effort. By way of example only, three more seams 18, 20, 22 are represented in FIG. 1, by which seams the shape of the inflated gas bag can specifically be influenced up into the edge portions. The dynamic properties of the gas bag can furthermore be influenced by the type of thread used for making the seams 16 to 22. When an elastic thread is used, the thread slack may be made shorter. Via the elasticity of the thread, the internal gas pressure of the gas bag 10 can be regulated, in that pressure variations are compensated via the elastic thread and an overload of the gas bag fabric is thus avoided.

FIGS. 6 to 10 show further embodiments of a gas bag according to the invention and with various tether means. The various tether means are disposed between the two plies of fabric 12, 14 of the gas bag 10 and may for instance be disposed in the middle of the gas bag 10 instead of the seam 16.

The reference numerals of components already known from the first embodiments will be maintained.

In the embodiment shown in FIG. 6, the tether means consists of an X-shaped tether structure 32. This structure 32 can be prefabricated outside the gas bag 10, in order to facilitate processing. Two ends of the X are each sewn to the one ply of fabric 12, and the other two ends are sewn to the other ply of fabric 14, each by means of seams 34. By means of a tether means, the four fastening seams on the one hand ensure a constant gas bag thickness over a larger area, and on the other hand the load is distributed across a large surface area of the gas bag fabric in the case of restraint.

FIG. 7 illustrates an X-shaped tether structure which is formed by two tethers 33. The tethers 33 are centrally connected with each other by a tear seam 30, whereby the X shape of the tether means is formed. The function of the tear seam 30 is to delimit the internal gas pressure, in that the tear seams tear at an increased internal gas pressure. With constant gas volume the gas bag volume is thereby increased, so that the internal gas pressure is decreased.

Another possibility for forming a tether means is shown in FIG. 8, where the tether means is formed of folds 36 of the plies of fabric 12, 14, which folds are sewn to each other. The plies of fabric 12, 14 are cut out with the corresponding clearance and laid in folds 36. The folds 36 are on the one hand sewn to each other (seam 38) and on the other hand taken in at the respective ply of fabric (seams 40). Since the seams 38, 40 may be made relatively long, the load acting of the gas bag fabric is also reduced in this case. There may also be provided a plurality of sewn folds 36. The sewn folds 36 may be used for forming chambers, possibly with interruptions, in order to allow a gas exchange between the individual chambers.

Another possibility of designing the tether means is shown in FIG. 9, where a circular piece of material 42, e.g. of gas bag fabric, is sewn to the one ply of fabric 12 at its peripheral edge 44, so as to form a large load zone, and to the other ply of fabric 14 at a middle portion 46, either likewise by means of a circular seam or only at individual points. When the gas bag 10 has been inflated, the piece of material 42 approximately conically extends between the two plies of fabric 12, 14. Other shapes of the piece of material 42 are also conceivable.

In the embodiment shown in FIG. 10, the tether means constitutes a catch thread 48. The catch thread 48 meanders between the two plies of fabric 12, 14 and via seams 50 is alternately connected with the plies of fabric 12, 14 at points 52. The distance d of the seams 50 substantially corresponds to the desired thickness of the inflated gas bag. In this embodiment, too, there is on the one hand achieved a constant thickness over a large area of the gas bag with only one tether means, and on the other hand the forces occurring in the case of restraint are distributed over a large-surface area of the gas bag fabric. Corresponding to the embodiment shown in FIGS. 2 to 4, the internal gas pressure and the dynamic properties of the gas bag can be controlled here as well via an elastic thread.

A possible method for manufacturing the catch thread illustrated in FIG. 10 is represented in FIG. 11. The superimposed plies of fabric are unfolded from one end 54 to an area provided for the catch thread 48. Subsequently, the catch thread 48 is disposed so as to continuously meander on the inside of the partly unfolded plies of fabric 12, 14 and via seams 50 is alternately attached to the points 52 with one of the plies of fabric 12, 14 each. The distance d of the points 52 substantially corresponds to the desired thickness of the inflated gas bag. Subsequently, the plies of fabric can be folded one over the other and be sealed gastight at their borders by means of a seam. The thread slack then is disposed between the two plies of fabric 12, 14 in the interior of the gas bag.

1. A gas bag for a vehicle occupant restraint system, comprising two superimposed plies of fabric and a tether means attached to the plies of fabric, said tether means being formed by at least one seam realized with a thread slack and interconnecting said plies of fabric.

2. The gas bag as claimed in claim 1, wherein the thread slack of the seam is provided on an outside of the gas bag as long as the gas bag is not inflated.

3. The gas bag as claimed in claim 1, wherein the seam is a lock stitch seam.

4. The gas bag as claimed in claim 3, wherein the seam is a double saddle stitch seam.

5. The gas bag as claimed in claim 3, wherein the thread slack is formed in an underthread.

6. The gas bag as claimed in claim 1, wherein the seam is a chain stitch seam.

7. The gas bag as claimed in claim 6, wherein the seam is a double chain stitch seam.

8. The gas bag as claimed in claim 6, wherein the thread slack is formed in an underthread.

9. The gas bag as claimed in claim 1, wherein the seam is made of an elastic material.

10. A device for producing a seam realized with a thread slack in a gas bag as claimed in claim 3, comprising at least one spacer, which substantially has a thickness corresponding to a desired thickness of the gas bag in an inflated condition, said spacer during a sewing operation being disposed between the two plies of fabric and removed after the sewing operation is completed.

11. A gas bag for a vehicle occupant restraint system, comprising two superimposed plies of fabric and a tether means formed by an X-shaped textile structure attached to each ply of fabric at two points of attachment on each ply of fabric.

12. The gas bag as claimed in claim 11, wherein the X-shaped textile structure is formed by two tethers which are connected with each other by a tear seam.

13. A gas bag for a vehicle occupant restraint system, comprising two superimposed plies of fabric and a tether means formed of a circular piece of textile material which at an outer periphery is connected over an area with one ply of fabric and in a middle area is connected over an area with another one of the plies of fabric.

14. A gas bag for a vehicle occupant restraint system, comprising two superimposed plies of fabric and a tether means formed by a pair of folds interconnected by a seam, each ply of fabric having one of said folds formed by two superimposed layers, the folds being located inside of the gas bag.

15. A gas bag for a vehicle occupant restraint system, comprising two superimposed plies of fabric (12, 14) and a tether means formed of a catch thread lying between the two plies of fabric with a thread slack, said catch thread being alternately attached to the plies of fabric at multiple points.

16. The gas bag as claimed in claim 15, wherein the catch thread is made of an elastic material.
